(19) United States
(12) Patent Application Publication
(10) Pub. No.: US 2008/0167590 A1
(43) Pub. Date: Jul. 10, 2008

(54) Apparatus For Caring Skin

(75) Inventors: Yongbok Jon, Seoul (KR); Daehwan Cha, Seoul (KR)

Correspondence Address: HARNESS, DICKEY & PIERCE, P.L.C., P.O. BOX 828, BLOOMFIELD HILLS, MI, 48303, US

(73) Assignees: Ke Hak CHO, Gyunggi-do (KR); Yongbok JON, Seoul (KR)

(21) Appl. No.: 11/884,694

(22) PCT Filed: Feb. 21, 2006
(86) PCT No.: PCT/KR2006/000577

§ 371 Date: Aug. 20, 2007

(30) Foreign Application Priority Data
Feb. 22, 2005 (KR) 10-2005-0014542

(51) Int. Cl. A61H 23/04

(52) U.S. Cl. 601/160

(57) ABSTRACT

A skin care apparatus is disclosed. The skin care apparatus includes a main body; a vessel being replaceable with a new one and installed in the main body for containing skin care materials; a head portion provided at one end of the main body; a material spraying member ins tailed in the head portion and provided with at least one spray hole formed through the plate surface thereof for spraying the skin care materials; a connection pipe for connecting the spray hole of the material spraying member to the vessel; a brush member detachably connected to the head portion for discharging the skin care materials sprayed from the spray holes to the outside; a vibration member for selectively vibrating the brush member; and a switching unit for selectively operating the vibration member and opening and closing the spray holes of the material spraying member. The skin care apparatus has a simple structure, is easily portable and used anywhere at any time, and increases skin care efficiency.

### TECHNICAL FIELD

The present invention relates to a skin care apparatus, and more particularly to a skin care apparatus, which has a simple structure, is easily portable and used anywhere at any time, and increases skin care efficiency.

### BACKGROUND ART

As living conditions are improved and participation of women in public affairs is increased these days, women frequently receive skin care so as to remove horny layers, freckles and acne from a skin, to tighten the sagging skin by removing wrinkles from the skin, and to whiten the skin. Accordingly, skin care shops have rapidly spread. This means that the skin care is not a luxury or an extravagance any more.

Further, general persons, who are not involved in specific show business, try out various skin care procedures without distinction of age or sex so as to maintain youthful, white, and resilient skin for displaying their originality or obtaining a confident manner toward other people.

Most of skin care apparatuses, which are used in skin care shops, are medical apparatuses. A method for using the conventional skin care apparatuses will be described, as below.

A designated skin care agent is deposited on one surface of a pad. Then, the pad is put on a region of a skin to be treated, and a low frequency or high frequency current or an alternating current is applied to the pad so that the skin care agent permeates the skin by means of the current.

Accordingly, the conventional skin care apparatuses require a component, such as a converter, for converting general power into the low frequency or high frequency current or the alternating current, thus being increased in size and production costs. Thus, general persons are reluctant to purchase them. Moreover, the conventional skin care apparatuses having a large size cannot be easily used anywhere at any time.

At this point, the present applicant has invented a skin care apparatus, which has a simple structure, is easily portable and used anywhere at any time, and increases skin care efficiency.

### DISCLOSURE OF INVENTION

### Technical Problem

Therefore, the present invention has been made in view of the above problems, and it is an object of the present invention to provide a skin care apparatus, which has a simple structure, is easily portable and used anywhere at any time, and increases skin care efficiency.

### ADVANTAGEOUS EFFECTS

The skin care apparatus of the present invention has a simple structure, is easily portable and used anywhere at any time, and increases skin care efficiency.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view of a skin care apparatus in accordance with a first embodiment of the present invention;

FIG. 2 is an exploded perspective view of the skin care apparatus of FIG. 1 from a designated angle;

FIG. 3 is an exploded perspective view of the skin care apparatus of FIG. 1 from another designated angle;

FIG. 4 is a schematically longitudinal sectional view of the skin care apparatus of FIG. 1;

FIG. 5 is a longitudinal sectional view of a skin care apparatus in accordance with a second embodiment of the present invention; and

FIG. 6 is a front view of the skin care apparatus of FIG. 5.

### BEST MODE FOR CARRYING OUT THE INVENTION

In accordance with an aspect of the present invention, the above and other objects can be accomplished by the provision of a skin care apparatus comprising a main body; a vessel being replaceable with a new one and installed in the main body for containing skin care materials; a head portion provided at one end of the main body; a material spraying member installed in the head portion and provided with at least one spray hole formed through the plate surface thereof for spraying the skin care materials; a connection pipe for connecting the spray hole of the material spraying member to the vessel; a brush member detachably connected to the head portion for discharging the skin care materials sprayed from the spray holes to the outside; a vibration member for selectively vibrating the brush member; and a switching unit for selectively operating the vibration member and opening and closing the spray holes of the material spraying member.

A vessel replacing portion for replacing the vessel with a new one may be detachably connected to the main body.

The brush member may comprise a body having a plate shape; and a plurality of contact protrusions formed on the plate surface of the body and made of a flexible material so that the contact protrusions elastically contact a skin.

The vibration member and the brush member may be detachably connected to the head portion.

In accordance with another aspect of the present invention, there is provided a skin care apparatus comprising: a main body for containing skin care materials therein; a head portion detachably connected to one end of the main body; a material spraying member installed in the head portion and provided with at least one spray hole formed through the plate surface thereof for spraying the skin care materials; a connection pipe for transferring the skin care materials in the main body to the spray hole; a pumping u nit provided at one end of the connection pipe for selectively pumping the skin care materials in the main body; a brush member detachably connected to the head portion for discharging the skin care materials sprayed from the spray holes to the outside; a vibration member for selectively vibrating the brush member; and a switching unit for selectively operating the vibration member and the pumping unit.

### MODE FOR THE INVENTION

Now, preferred embodiments of the present invention will be described in detail with reference to the annexed drawings.

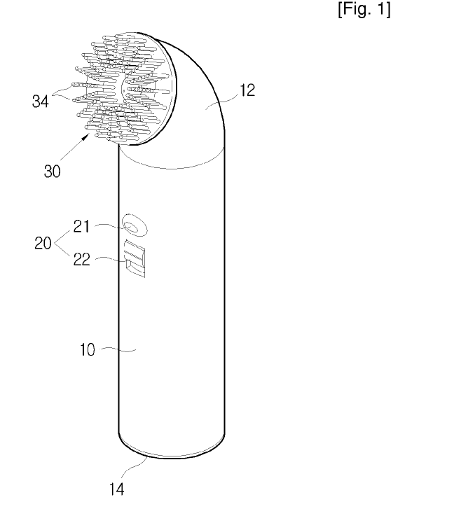

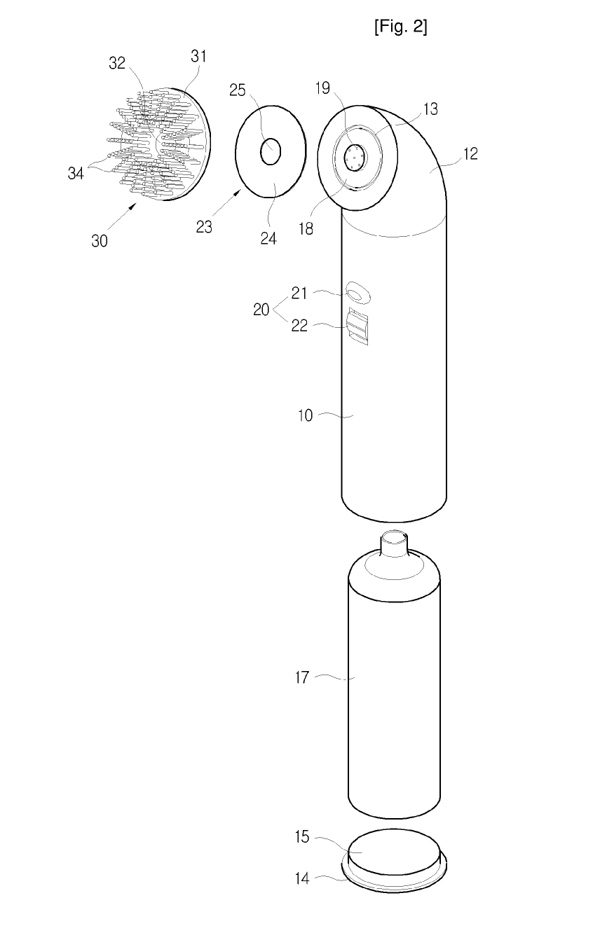

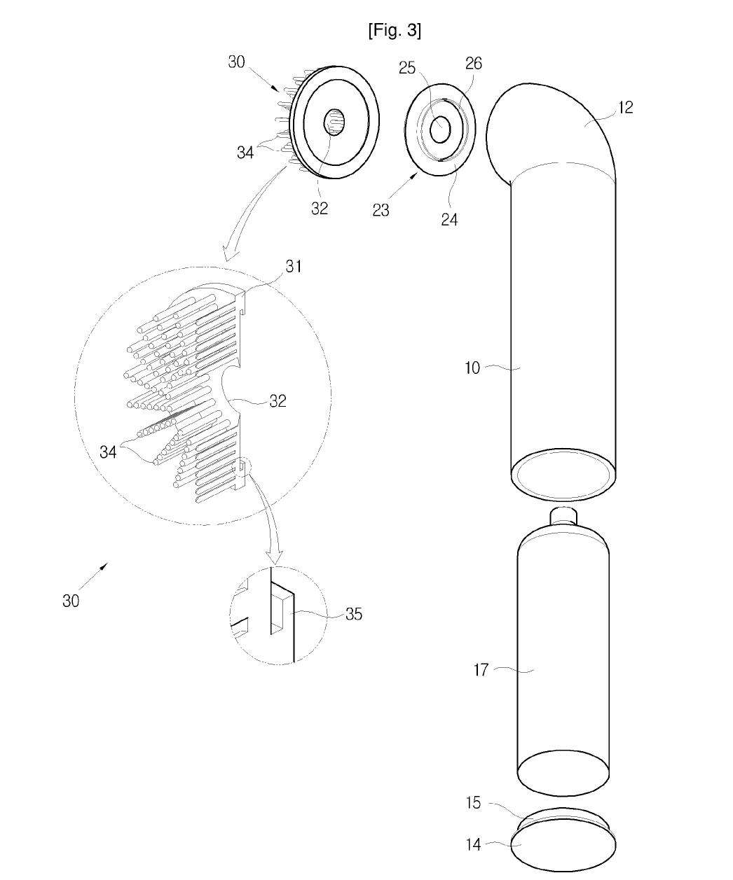

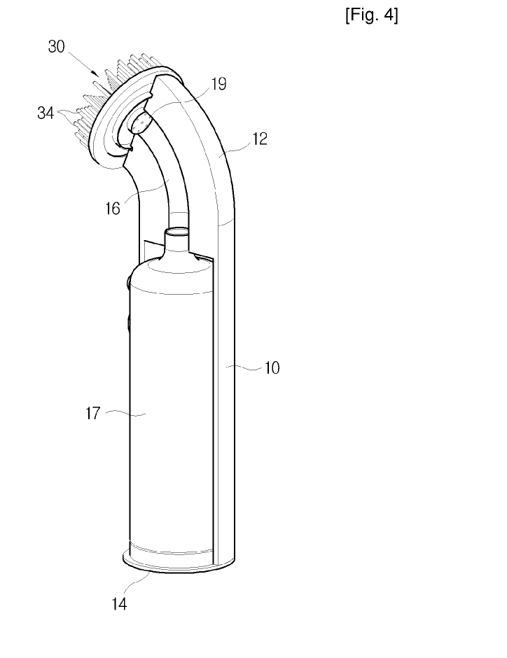

FIG. 1 is a perspective view of a skin care apparatus in accordance with a first embodiment of the present invention, FIG. 2 is an exploded perspective view of the skin care apparatus of FIG. 1 from a designated angle, FIG. 3 is an exploded perspective view of the skin care apparatus of FIG. 1 from another designated angle, and FIG. 4 is a schematically longitudinal sectional view of the skin care apparatus of FIG. 1.

As shown in FIGS. 1 to 4, the skin care apparatus in accordance with the first embodiment of the present invention comprises a main body 10, a head portion 12 connected to one end of the main body 10, and a vessel replacing portion 14 detachably connected to the other end of the main body 10.

The main body 10 forms the frame of the skin care apparatus, and has a tubular structure, as shown in FIGS. 1 to 4. However, the main body 10 may have the structure of a triangular prism or a square pillar. Although not shown in the drawings, a skid-proof unit may be formed in the main body 10. The skid-proof unit comprises a pad or an uneven surface.

A switching unit 20 is formed on the outer surface of the main body 10. The switching unit 20 comprises a vibration button 21 for controlling the operation of a vibration member 23, which will be described later, and a material button 22 for selectively spraying skin care materials contained in a vessel 17. The switching unit 20 is operated by an electrical signal from a battery 15.

The vessel replacing portion 14 is detachably connected to the lower end of the main body 10. Accordingly, the vessel 17 in the main body 10 is easily replaced with a new one through the vessel replacing portion 14. Further, the battery 15 serving as a power supply for operating the skin care apparatus is also easily replaced with a new one through the vessel replacing portion 14.

The vessel 17, which can be easily replaced with a new one through the vessel replacing portion 14, is disposed in the main body 10. The vessel 17 contains designated skin care materials. The skin care materials refer to all kinds of materials, such as facial lotions, skins, and cream, which are applied directly to skin to exhibit a massage effect and to remove a horny layer from the skin.

The head portion 12 is installed on the upper end of the main body 10. The head portion 12 is bent in a designated shape from the main body 10 having a rectilinear shape, thus being conveniently used. Accordingly, a user easily grasps the main body 10 by hand and makes the head portion 12 contact a skin, particularly a face.

A material spraying member 18 is prepared in the head portion 12. A plurality of spray holes 19 are formed through the plate surface of the material spraying member 18 so that the skin care materials in the vessel 17 are sprayed to the outside of the head portion 12 through the spray holes 19. For this reason, the spray holes 19 of the material spraying material 18 are connected to the vessel 17 by a separate connection pipe 16.

When the material button 22 of the switching unit 20 is manipulated in one direction, the skin care materials contained in the vessel 17 are sprayed from the spray holes 19 of the material spraying member 18 through the connection pipe 16, and when the material button 22 is manipulated in the other direction, the spray of the skin care materials is stopped. For the reason, the vessel 17 employs the structure of a conventional shampoo or spray bottle. The vessel 17 may employ the technique of a hair and cosmetic instrument, which was filed by the present applicant and was registered.

A vibration member 23 for selectively vibrating a brush member 30, which will be described later, is connected to the head portion 12. The vibration member 23 comprises a vibrating table 24, which is selectively vibrated by the vibration button 21 of the switching unit 20, and a connecting rib 26, which is formed integrally on the vibrating table 24 and inserted into a slot 13 formed in the plate surface of the head portion 12. A first through hole 25 for allowing the skin care materials to be sprayed from the spray holes 19 toward the brush member 30 is formed through the central portion of the vibrating table 24. For reference, the vibrating table 24 is vibrated by an electrical signal from the battery 15. Accordingly, a separate PCB for vibrating the vibrating table 24 may be installed, and a unit for amplifying a signal and then outputting a high frequency signal or an ultrasonic signal may be installed on the PCB.

The brush member 30 comprises a body 31 having a plate shape, and a plurality of contact protrusions 34 formed on the plate surface of the body 31 and made of a flexible material so that the contact protrusions 34 elastically contact a skin. The brush member 30 is detachably connected to the vibrating table 24 so that the dirty contact protrusions 34 can be easily washed or replaced with new ones.

A hook portion 35 for connecting the brush member 30 to the vibration member 23 is formed on the body 31 of the brush member 30. Preferably, the hook portion 35 is cut at a designated portion so that the hook portion 35 is more easily connected to the vibration member 23. A second through hole 32 for finally passing the skin care materials is formed through the brush member 30.

Hereinafter, a method for using the above skin care apparatus of the present invention will be described.

After a user holds the main body 10, the user makes the contact protrusions 34 of the brush member 30 contact a skin to be treated, such as a face. Thereafter, the user manipulates the material button 22 of the switching unit 20 in one direction. Then, the skin care materials contained in the vessel 17 are sprayed from the spray holes 19 of the material spraying member 18 through the connection pipe 16, and are transferred to the skin through the first through hole 25 of the vibration member 23 and the second through hole 32 of the brush member 30.

In the above state, the user manipulates the vibration button 21 of the switching unit 20. Then, the vibrating table 24 is vibrated at a regular position, thus vibrating the brush member 30 connected thereto. Accordingly, the contact protrusions 34 contacting the skin massage the skin, and the skin care materials sprayed from the spray holes 19 are absorbed into the skin and thus increase the massage effect. When the use of the skin care apparatus is completed, the switching unit 20 is turned off.

Consequently, the skin care apparatus of the present invention has a simple structure, is easily portable and used anywhere at any time, and increases skin care efficiency.

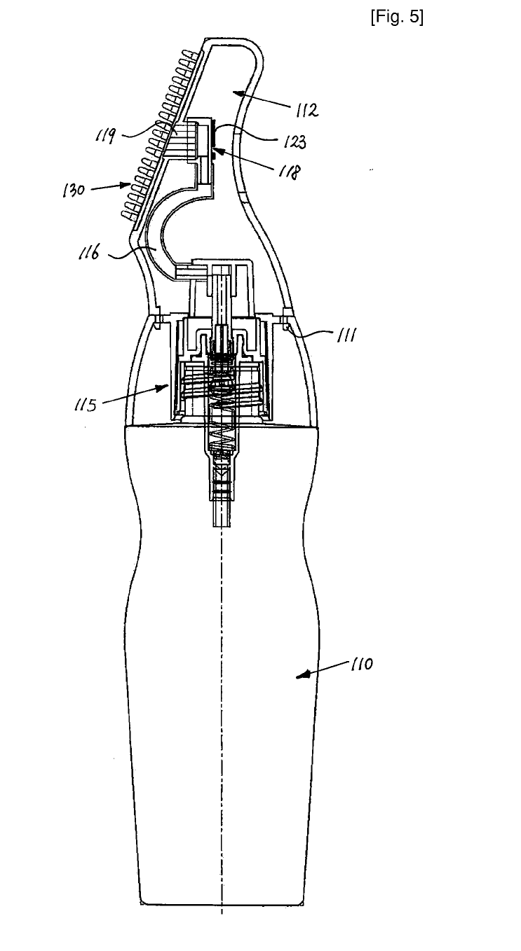

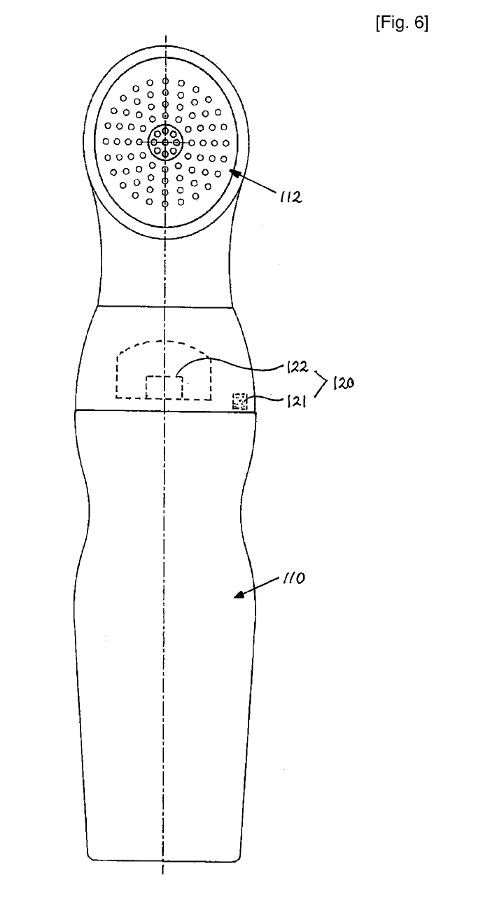

FIG. 5 is a longitudinal sectional view of a skin care apparatus in accordance with a second embodiment of the present invention, and FIG. 6 is a front view of the skin care apparatus of FIG. 5.

With reference to FIGS. 5 and 6, the skin care apparatus of the second embodiment does not have the vessel 17, differing from the skin care apparatus of the first embodiment, and skin care materials are contained in a main body 110.

A head portion 112 is detachably connected to one end of the main body 110 using a hook 111. A material spraying member 118 provided with spray holes 119 for spraying the skin care materials is installed in the head portion 112. The spray holes 119 of the material spraying member 118 are connected to the inside of the main body 110 containing the skin care materials by a connection pipe 116.

A pumping unit 115 for selectively pumping the skin care materials in the main body 110 is provided at one end of the connection pipe 116. The pumping unit 115 serves to pump the skin care materials by the manipulation of a material button 122 of a switching unit 120, and employs the structure of a pumping unit of a hair and cosmetic instrument, which was filed by the present applicant.

A brush member 130, which is made of a flexible material and discharges the skin care materials sprayed from the spray holes 119 to the outside, is provided at one end of the head portion 112. The brush member 130 may have the same structure of the brush member 30 of the skin care apparatus of the first embodiment. However, the brush member 130 may be replaced with a comb.

A vibration member 123 for selectively vibrating the brush member 130 is provided in the rear of the material spraying member 118. The vibration member 123 is selectively switched on and off by the manipulation of a vibration button 121 of the switching unit 120.

### INDUSTRIAL APPLICABILITY

The present invention provides a skin care apparatus, which has a simple structure, is easily portable and used anywhere at any time, and increases skin care efficiency.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A skin care apparatus comprising:
a main body;
a vessel being replaceable with a new one and installed in the main body for containing skin care materials;
a head portion provided at one end of the main body;
a material spraying member installed in the head portion and provided with at least one spray hole formed through the plate surface thereof for spraying the skin care materials;
a connection pipe for connecting the spray hole of the material spraying member to the vessel;
a brush member detachably connected to the head portion for discharging the skin care materials sprayed from the spray holes to the outside;
a vibration member for selectively vibrating the brush member; and
a switching unit for selectively operating the vibration member and opening and closing the spray holes of the material spraying member.

2. The skin care apparatus as set forth in claim 1, wherein a vessel replacing portion for replacing the vessel with a new one is detachably connected to the main body.

3. The skin care apparatus as set forth in claim 1, wherein the brush member comprises:
a body having a plate shape; and
a plurality of contact protrusions formed on the plate surface of the body and made of a flexible material so that the contact protrusions elastically contact a skin.

4. The skin care apparatus as set forth in claim 1, wherein the vibration member and the brush member are detachably connected to the head portion.

5. A skin care apparatus comprising:
a main body for containing skin care materials therein;
a head portion detachably connected to one end of the main body;
a material spraying member installed in the head portion and provided with at least one spray hole formed through the plate surface thereof for spraying the skin care materials;
a connection pipe for transferring the skin care materials in the main body to the spray hole;
a pumping unit provided at one end of the connection pipe for selectively pumping the skin care materials in the main body;
a brush member detachably connected to the head portion for discharging the skin care materials sprayed from the spray holes to the outside;
a vibration member for selectively vibrating the brush member; and
a switching unit for selectively operating the vibration member and the pumping unit.
